(19) United States
(12) Patent Application Publication
(10) Pub. No.: US 2019/0247780 A1
(43) Pub. Date: Aug. 15, 2019

(54) Easy change filter system For a Vehicle

(71) Applicants: Dan Conrad, Yorba Linda, CA (US); Randy Reams, Orange, CA (US)

(72) Inventor: Randy Reames, Orange, CA (US)

(21) Appl. No.: 15/894,363

(22) Filed: Feb. 12, 2018

(51) Int. Cl. B01D 46/42; B01D 46/00; B01D 46/10; B01D 46/24

(52) U.S. Cl. CPC B01D 46/4227; B01D 46/0006; B01D 2279/60; B01D 46/24; B01D 46/10

(57) ABSTRACT

A quick change filter which allows changing an air filter from an exterior of the vehicle. A portion of the air filter extends outside the plane of the vehicle body, and can be removed to remove the filter. A new filter can then be inserted. The filter is held in place with tabs. One embodiment uses a cylindrical air filter where the air is input to the center of the filter and passes through the filter into an air chamber that holds clean air. The air chamber provides air to a manifold which drives the internal combustion engine.

### BACKGROUND

Air filters on certain vehicles, such as off-road vehicles, must be changed often in order to allow for optimum performance. Current air filters are accessed by removing a cover, e.g. the seat, a side panel or some other panel, to expose the air filter. The filter once exposed can be removed and cleaned or replaced.

This is inconvenient because it requires the user to take apart different parts in order to replace or clean such a filter. Because it is inconvenient, the driver may actually change the air filter less often. This is bad for the vehicle, and also means that the vendor of air filters sells less filter air filters than they normally would, if the user changed them on a more timely basis.

### SUMMARY

The present application describes a easy change filter which can be used on a motorcycle or off-road device, for example, which is easier to replace.

According to an embodiment, the filter can be accessed from the exterior of the vehicle, and easily changed.

### BRIEF DESCRIPTION OF THE DRAWINGS

In the Drawings:

FIG. 1 shows a first embodiment with a cylindrical filter in an airbox, with the filter partway out of the airbox;

FIG. 2 shows the first embodiment with the filter fully inserted into the airbox;

FIG. 3 illustrates the filter locked into place in the airbox of the first embodiment;

FIGS. 4 and 5 show the filter and the airbox separated from one another respectively;

FIG. 6 shows a cross-section of the airbox with its quarter turn locking feature;

FIGS. 7A-7C illustrate how the filter is inserted in the first embodiment;

FIGS. 8A and 8B illustrate a second embodiment with a rectangular filter;

FIG. 9 shows a rear view of the second embodiment;

FIG. 10 shows the locking clips.

### DETAILED DESCRIPTION

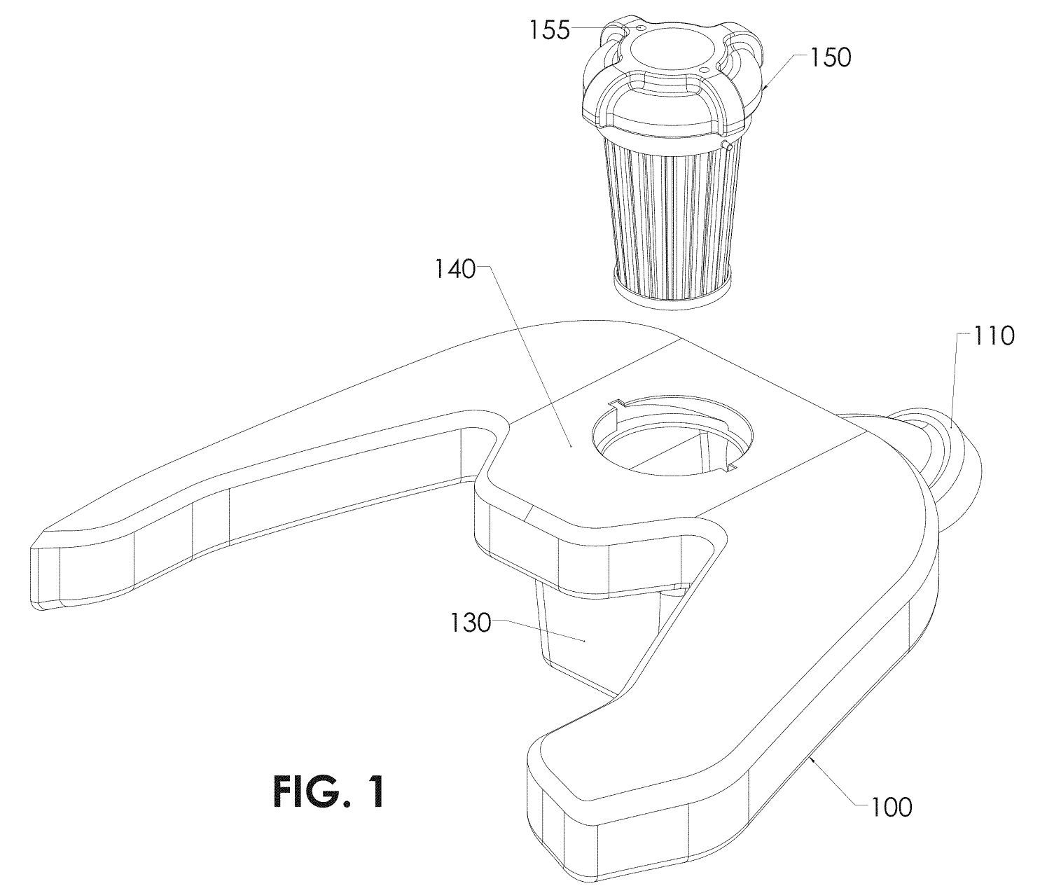

FIG. 1 shows an exemplary embodiment of an airbox diagram where the filter can easily be changed from the outside of the airbox. In FIG. 1, the airbox 100 leads to a manifold 110 which has a nipple portion that provides input air to the internal combustion engine. The manifold 110 may be connected to, for example, an internal combustion engine. The airbox includes an internal rectangular air chamber 130, and a filter inlet opening 140. The air can only be brought into the air chamber 130 by passing through the filter inlet 140.

Air filter 150 fits into the filter inlet to filter the air before the air passes into the air chamber 130. This air filter includes a cap 155 on its top portion which directs the inlet air into the central chamber of the cylindrical filter. The air passes through the filter, and the filtered air is exhausted into the air chamber 130. FIG. 1 illustrates the air filter being partly removed from the airbox 100.

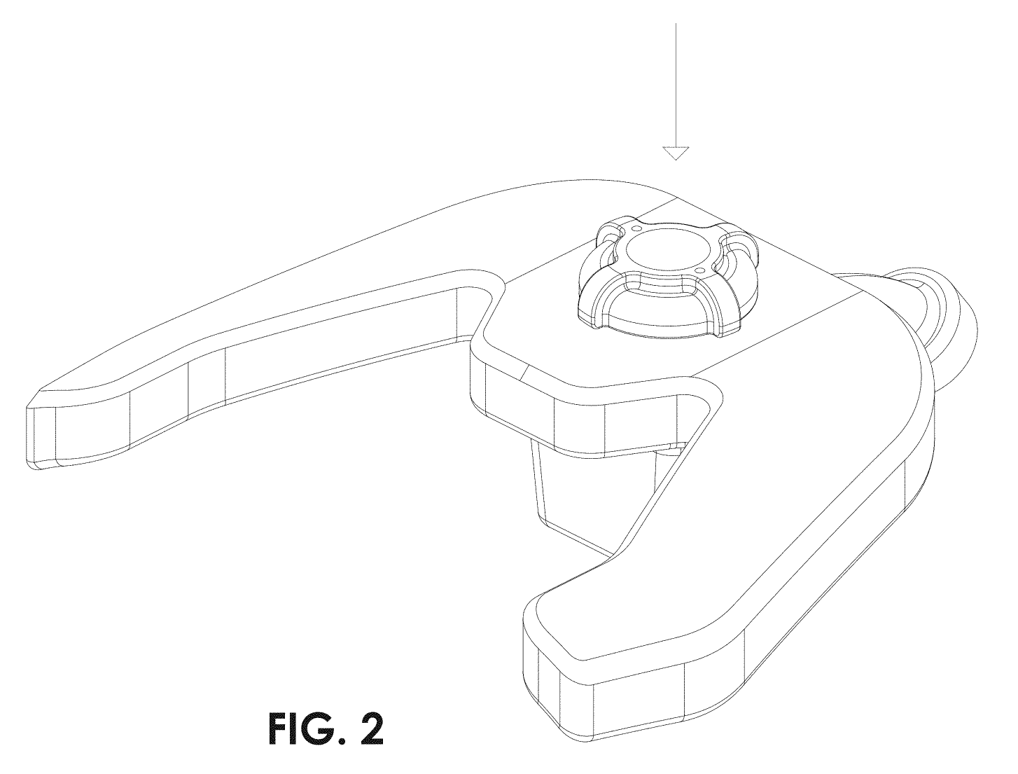

The filter can also be inserted completely into the airbox as shown in FIG. 2 so that air can only get into the air chamber 130, and hence to the manifold 110 by passing through the filter.

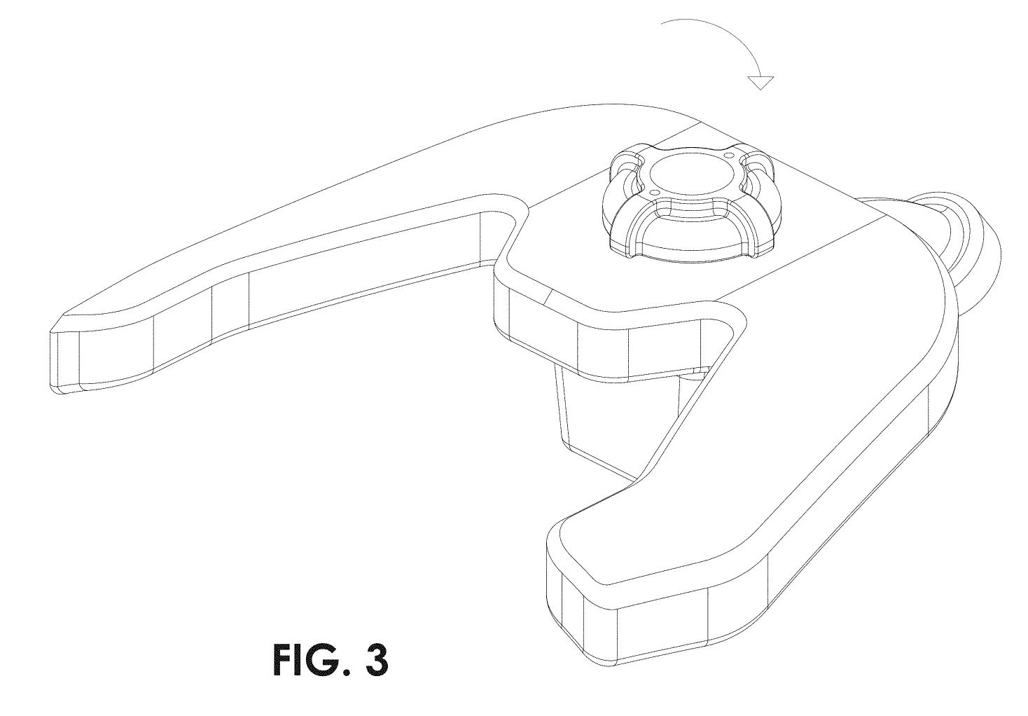

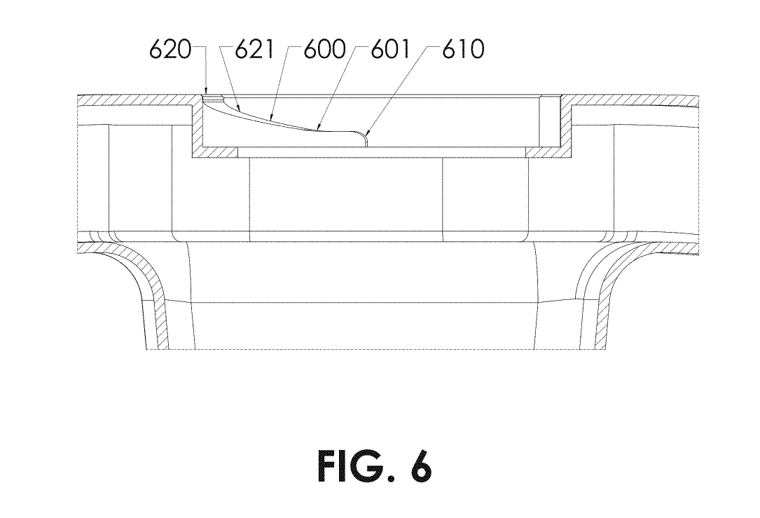

After the filter is inserted as shown in FIG. 2, the filter is twisted as shown in FIG. 3 to lock the filter into place using a quarter turn ramp, shown in further detail in FIG. 6.

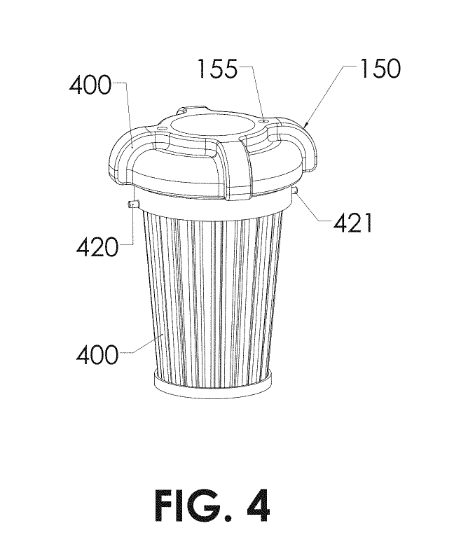

FIG. 4 illustrates a close-up of the air filter 150 is an assembly formed of an air filter 400 which is a replaceable part, attached to a locking cover 410. The locking cover includes tabs 420 and 421 at outer and opposite edges of the cover. These tabs extend outward from the locking cover.

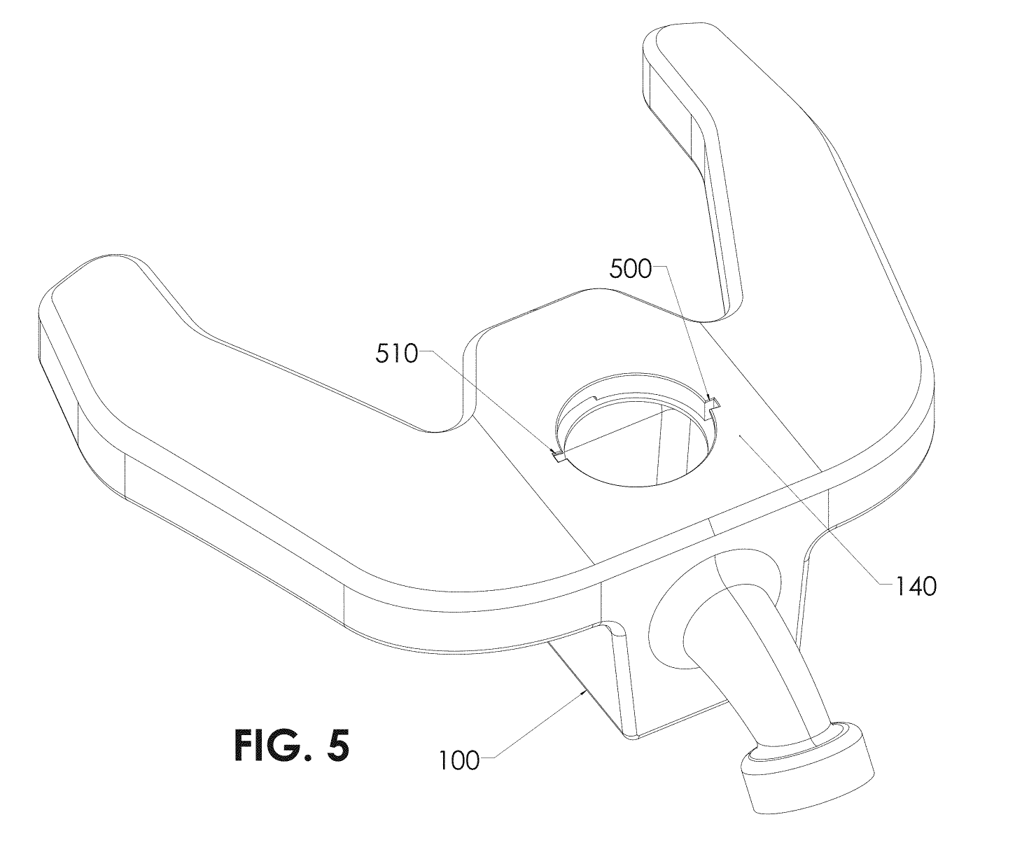

FIG. 5 shows a close-up of the airbox 100 and the filter opening 140. The filter opening 140 includes indentations 500, 510 which receive the tabs 420 and 421 respectively. Once the tabs are respectively received within the indentations 500, 510, the filter can be twisted to lock the tabs into place and hence lock the air filter cover and air filter into place.

In one embodiment, the filter indentations 500, 510 include a quarter turn feature shown as 600 in FIG. 6. In operation of this quarter turn feature, the tab when at its extreme leftmost position in FIG. 6 has an opening on top of the area at 620, so that the tabs can be removed from the airbox, and also inserted into the airbox. Once the tabs are inserted, the cover can be twisted so that the tab, e.g., 420, presses against the surface 621 which holds against the tab 420. As the cover is further twisted, the surface shown as 601 continues to push the tabs such as 420 downward, until reaching the end 610 of the surface at which point the tabs (and hence the air filter cover) are locked into place.

The indentation has a surface shown as 601 which gradually varies downward to a distal locked portion 610 to force the locking cover 410 further down by the interaction between the surface 601 and the tabs 420, 421.

Once locked into place, the filter stays there, and can only be removed by twisting in the opposite direction.

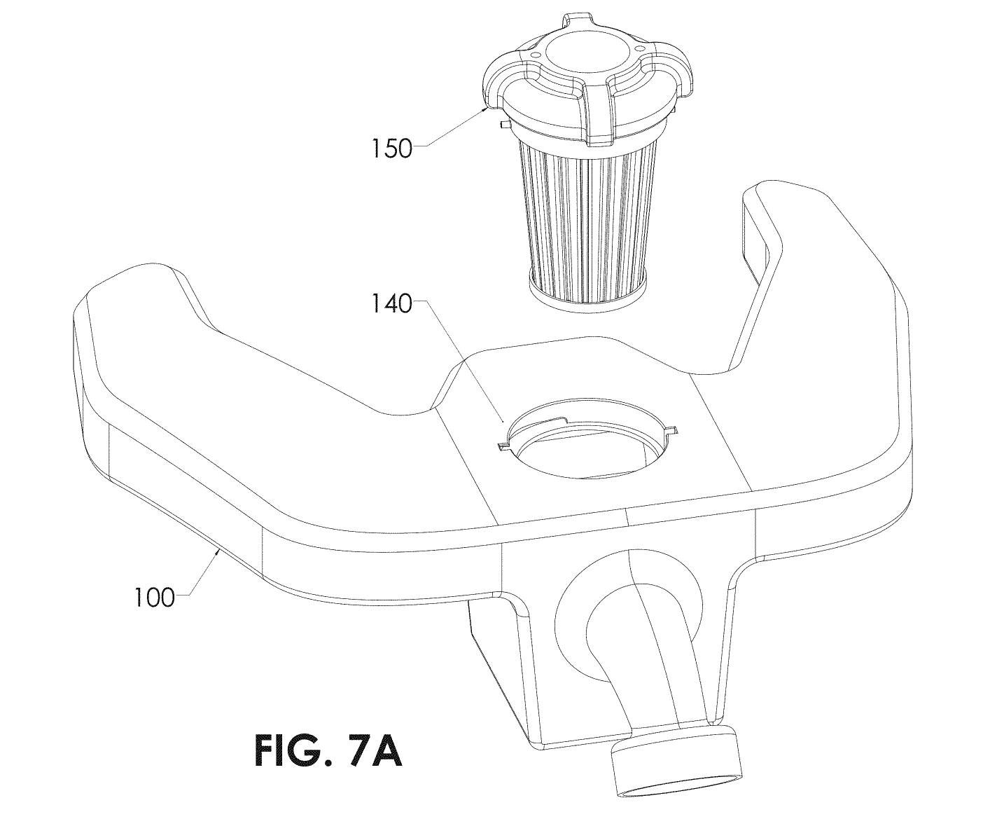

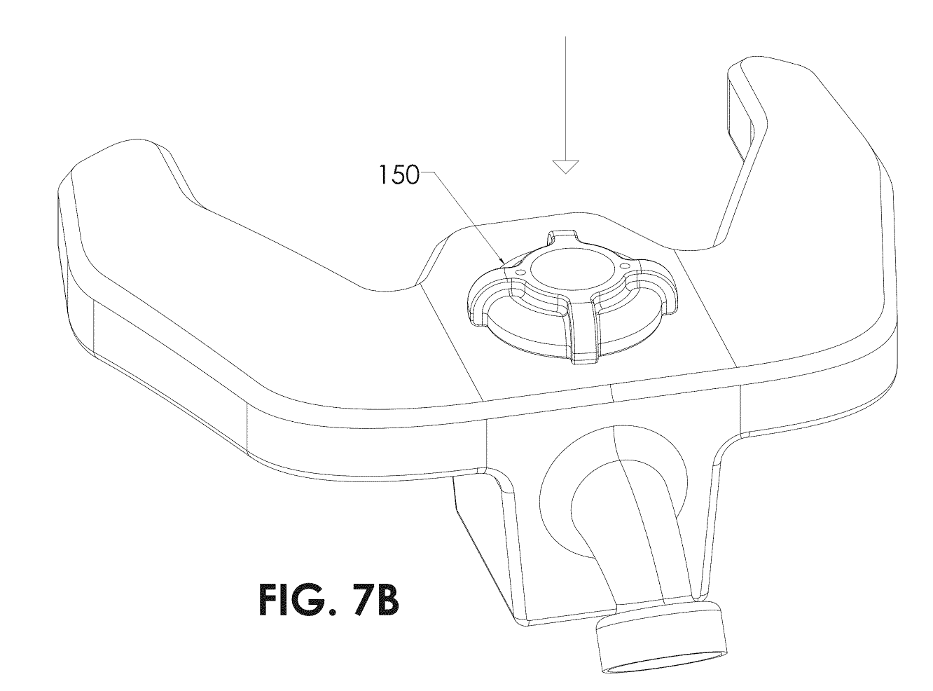

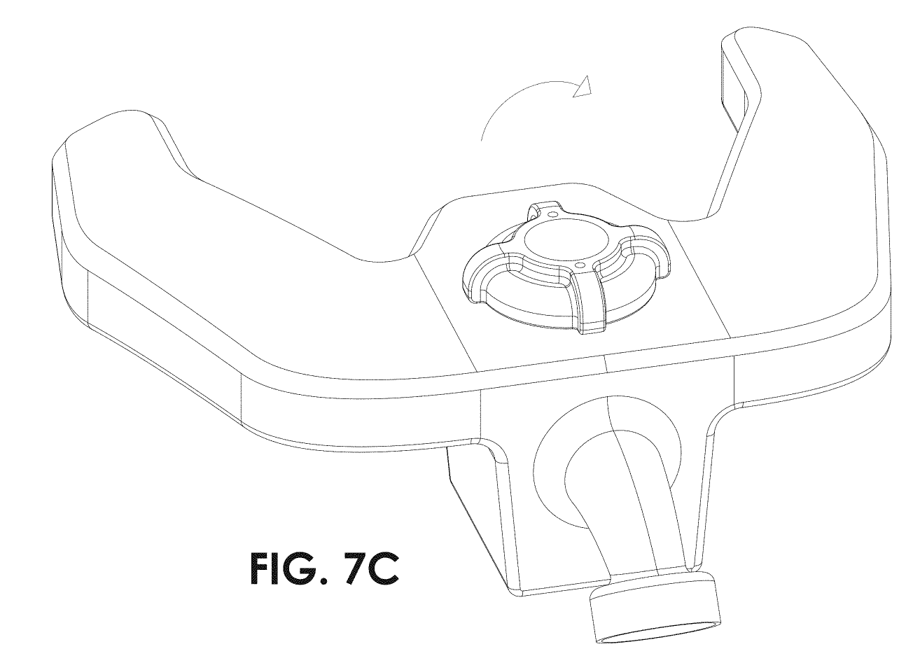

FIGS. 7A-7B show the insertion process in detail. In FIG. 7A, the filter has been removed, and either a new filter or cleaned filter is available. The filter assembly 150 is to be placed in the filter inlet 140 within the main body 100. In FIG. 7B, the filter 150 is pressed into place into the filter inlet 140, and then twisted as shown in FIG. 7C to lock the filter into place. At this point, the filter has been locked into place, and can only be removed through an opposite series of actions to the insertion process.

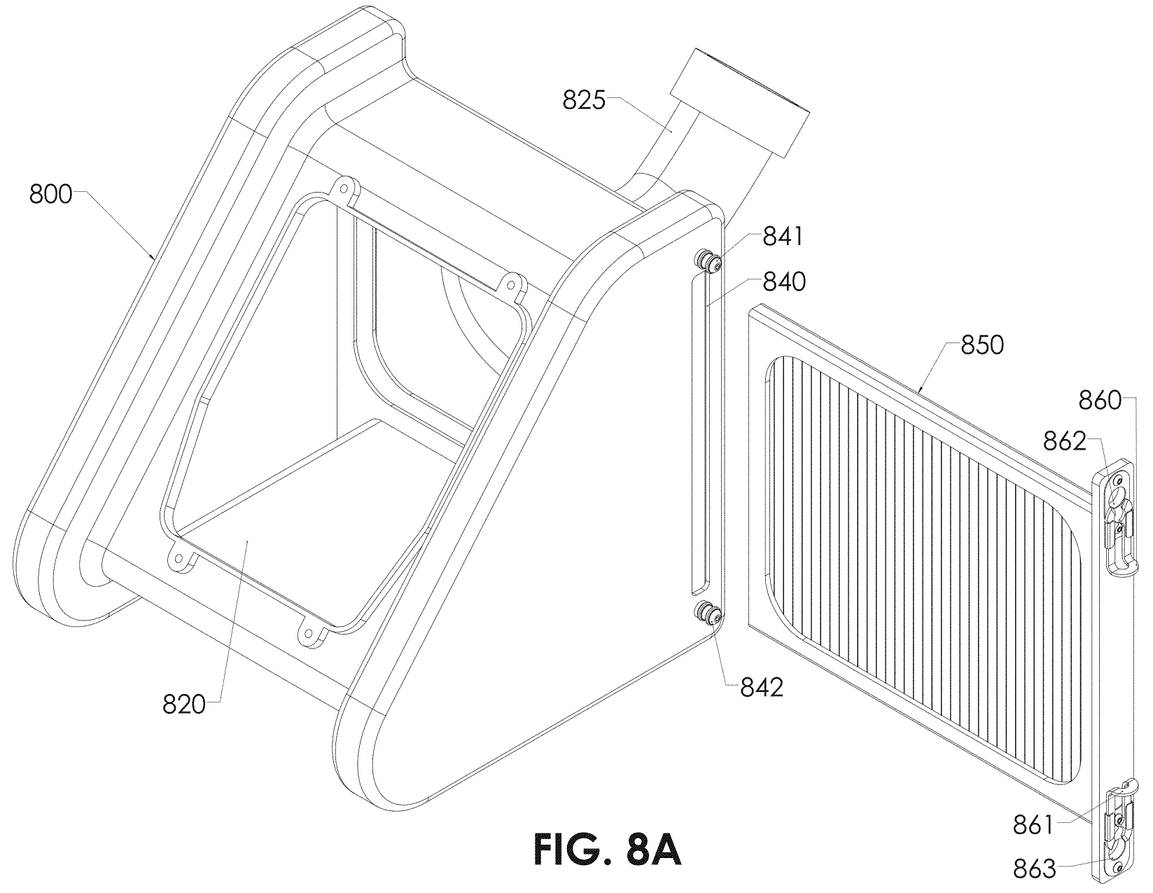

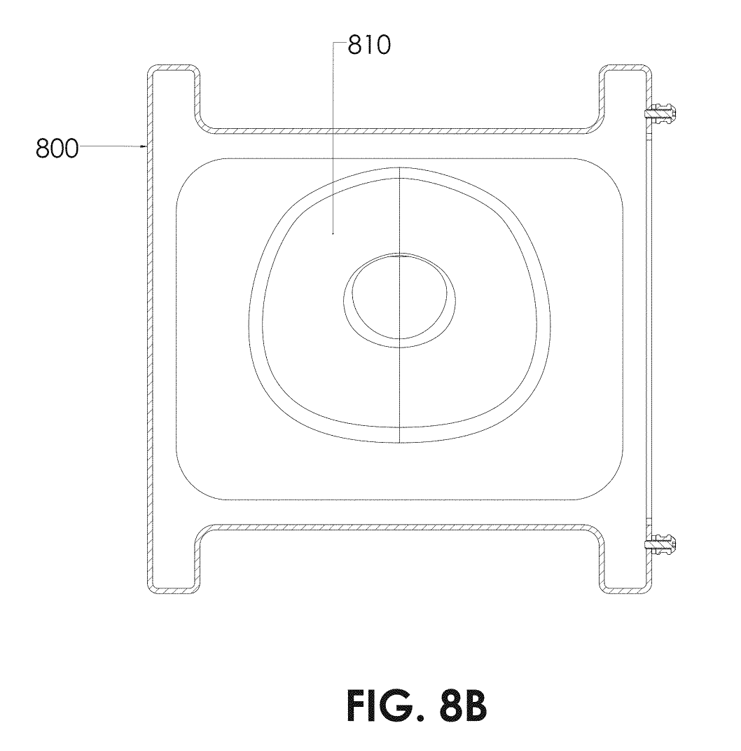

An alternative embodiment is shown in FIGS. 8A and 8B which shows an embodiment with a rectangular filter. FIG. 8A shows the rectangular housing from its rear in FIG. 8B shows the rectangular housing 800 from the front on. The housing 800 includes an opening 810 which leads to an air chamber. The air chamber is connected to a manifold 825 which receives inlet air. The housing 800 also includes an opening 840 on one side, into which filter 850 can be inserted and removed. When the filter 850 is in place, all the outside air from the manifold must pass through the filter before reaching the air chamber which is in communication with the vehicle.

The opening 840 includes a first tab 841 at the top, and a second tab 842 at the bottom. These tabs are used to lock the air filter into place.

In operation, the air filter includes clips 860 and 861. The air filter also includes holes such as 862 which are sized to fit around the tab 841. Once the air filter is inserted into place, the tabs 841 fit into the hole 862 and the tab 842 fits into the hole 863. At this point, the clip 860 is moved down to lock the top side of the filter into place and the clip 861 is moved down to lock the bottom into place.

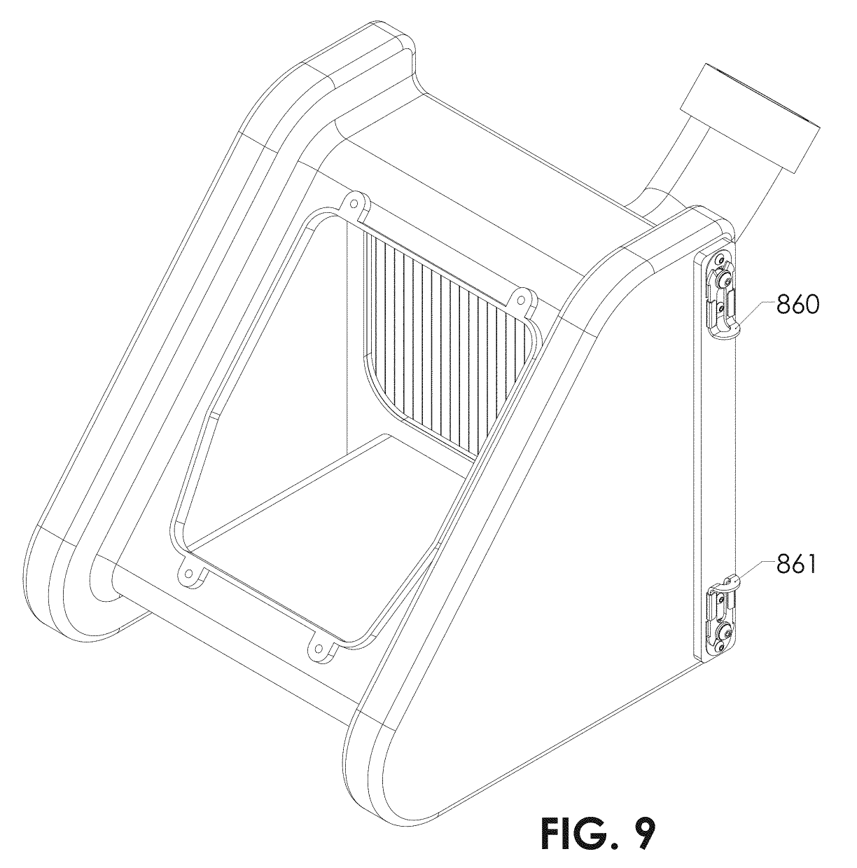

FIG. 9 illustrates the air filter with the air filter inserted, but the clips 860 and 861 in their open position.

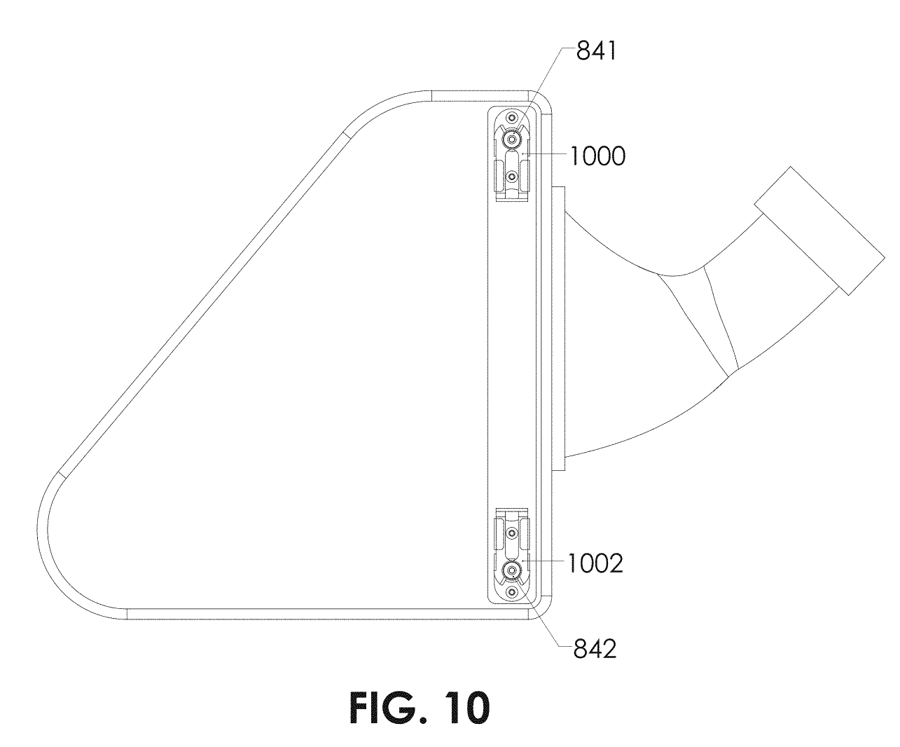

After the air filter is locked into place in this way, the clips are moved to the locked position shown in FIG. 10 where the clip surfaces 1000 are moved over the surfaces of the corresponding tab 841 and similarly, the clip surfaces 1002 are moved over the corresponding tab 842.

Although this shows only a few embodiments, it is understood that this is intended to cover other embodiments than those specifically shown.

For example, other sizes, and other designs can be used.

What is claimed is:

1. A removable air filter system, having:
an airbox, having an internal air receiving area, forming a chamber for air, and the airbox having a manifold, attached to said chamber for air, said manifold adapted for supplying air to an internal combustion engine, and having a nipple portion for providing the air to the internal combustion engine.
the airbox having an external surface, which faces to an external portion of the airbox, and having an opening that opens from the external surface into the air chamber, the opening including attachment surfaces for attaching an air filter by accessing from the external surface, the attachment surfaces including at least one indented portion adapted for holding a corresponding peg from the air filter to hold the air filter into place.

2. The air filter system as in claim 1, wherein the opening is a circular opening.

3. The air filter system as in claim 2, wherein the circular opening includes said indented portions at each of two opposite ends of the circular opening.

4. The air filter system as in claim 3, wherein the circular opening also includes first surfaces which press against the tabs to hold the tabs into place, and an area where the first surfaces are not located, to allow the tabs to be inserted.

5. The air filter system as in claim 4, wherein the first surfaces progressively lower into the airbox, and lock the tabs into place at an end of a progression of area of the first surfaces.

6. The system as in claim 4, further comprising an air filter, having an air filter holder part thereon, the air filter holder part having a portion which fits on a cylindrical air filter, and the air filter holder having first and second tabs which fit into the indented portions at the ends of the circular opening.

7. The system as in claim 6, wherein the air filter holder part includes an internal circular surface, and the air filter fits within the internal circular surface, and where the air filter holder part includes an opening on its top allowing air into a center of the cylindrical air filter, so that air from an outside of the air chamber must pass through the air filter in order to pass into the air chamber.

8. The filter as in claim 1, wherein the opening is a rectangular opening, and has first and second tabs for holding an air filter in place.

9. The filter as in claim 8, wherein the filter is substantially rectangular, and includes holes which fit over the tabs.

10. The filter as in claim 9, further comprising clips which can slide over the tabs once the tabs passed through the holes.

11. A method of changing an air filter on a vehicle, comprising:
changing an air filter from an outside surface of an airbox attached to the vehicle, without removing any covers from the vehicle, where the airbox having an internal air receiving area, forming a chamber for air, and the airbox having a manifold, attached to said chamber for air, said manifold adapted for supplying air to an internal combustion engine, and having a nipple portion for providing the air to the internal combustion engine, the airbox having an external surface, which faces to an external portion of the airbox, and having an opening that opens from the external surface into the air chamber, and said changing comprising attaching an air filter assembly to the opening using attachment surfaces for attaching the air filter by accessing from the external surface, the attachment surfaces including at least one indented portion adapted for holding a corresponding peg from the air filter to hold the air filter into place.

12. The method as in claim 11, wherein the opening is a circular opening, and the changing comprises inserting a cylindrical air filter assembly into the circular opening.

13. The method as in claim 12, wherein the inserting comprises inserting tabs from the air filter assembly into indented portions at each of two opposite ends of the circular opening.

14. The method as in claim 13, wherein the circular opening also includes first surfaces which press against the tabs to hold the tabs into place, and further comprising inserting the tabs in a location where the first surfaces are not located, and twisting the tabs, to press the tabs against the first surface.

15. The method as in claim 14, wherein the first surfaces extend progressively lower into the airbox, and further comprising locking the tabs into place at an end of a progression of area of the first surfaces.

16. The system as in claim 14, further comprising providing a cylindrical air filter into an air filter holder part, and the air filter holder having first and second tabs which fit into the indented portions at the ends of the circular opening, and locking the cylindrical air filter holder part into indented portions.

17. The system as in claim 16, wherein the air filter holder part includes an internal circular surface, and the air filter fits within the internal circular surface, and where the air filter holder part includes an opening on its top allowing air into a center of the cylindrical air filter, so that air from an outside of the air chamber must pass through the air filter in order to pass into the air chamber.
